(19) United States
(12) Patent Application Publication
(10) Pub. No.: US 2005/0246500 A1
(43) Pub. Date: Nov. 3, 2005

(54) Method, apparatus and system for an application-aware cache push agent

(76) Inventors: Ravishankar Iyer, Hillsboro, OR (US); Srihari Makineni, Portland, OR (US); Ram Huggahalli, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/834,593

(22) Filed: Apr. 28, 2004

(51) Int. Cl. G06F 12/00

(52) U.S. Cl. 711/137; 711/146

(57) ABSTRACT

In some embodiments, a method, apparatus and system for an application-aware cache push agent. In this regard, a cache push agent is introduced to push contents of memory into a cache of a processor in response to a memory read by the processor of associated contents. Other embodiments are described and claimed.

### FIELD OF THE INVENTION

Embodiments of the present invention generally relate to the field of caching schemes, and, more particularly to a method, apparatus and system for an application-aware cache push agent.

### BACKGROUND OF THE INVENTION

Processors used in computing systems, for example internet servers, operate on data very quickly and need a constant supply of data to operate efficiently. If a processor needs to get data from system memory that is not in the processor's internal cache, it could result in many idle processor clock cycles while the data is being retrieved. Some prior art caching schemes that try to improve processor efficiency involve pushing data into cache as soon as it is written into memory. One problem with these prior art schemes is that if the data is not needed until some time later, it may be overwritten and would need to be fetched from memory again. Another problem with these prior art schemes is that in a multi-processor system it would not always be possible to determine which processor will need the data.

### BRIEF DESCRIPTION OF THE DRAWINGS

The present invention is illustrated by way of example and not limitation in the figures of the accompanying drawings in which like references indicate similar elements, and in which:

FIG. 1 is a block diagram of an example computing system suitable for implementing the cache push agent, in accordance with one example embodiment of the invention;

FIG. 2 is a block diagram of an example cache push agent architecture, in accordance with one example embodiment of the invention;

FIG. 3 is a flow chart of an example method performed by a cache push agent, in accordance with one example embodiment of the invention; and

FIG. 4 is a block diagram of an example article of manufacture including content which, when accessed by a device, causes the device to implement one or more aspects of one or more embodiment(s) of the invention.

### DETAILED DESCRIPTION

Embodiments of the present invention are generally directed to a method, apparatus and system for an application-aware cache push agent. In this regard, in accordance with but one example implementation of the broader teachings of the present invention, a cache push agent is introduced. In accordance with but one example embodiment, the cache push agent employs an innovative method to push contents of memory into a cache of a processor in response to a memory read by the processor of associated contents. According to one example method, the cache push agent may maintain a table of memory writes by an input/output (I/O) device, such as, for example, a network controller, graphics controller, or disk controller, among others. According to another example method, the cache push agent may snoop for memory reads by a processor and determine what, if any, data to push into the cache of that processor, as described hereinafter.

In the following description, for purposes of explanation, numerous specific details are set forth in order to provide a thorough understanding of the invention. It will be apparent, however, to one skilled in the art that embodiments of the invention can be practiced without these specific details. In other instances, structures and devices are shown in block diagram form in order to avoid obscuring the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

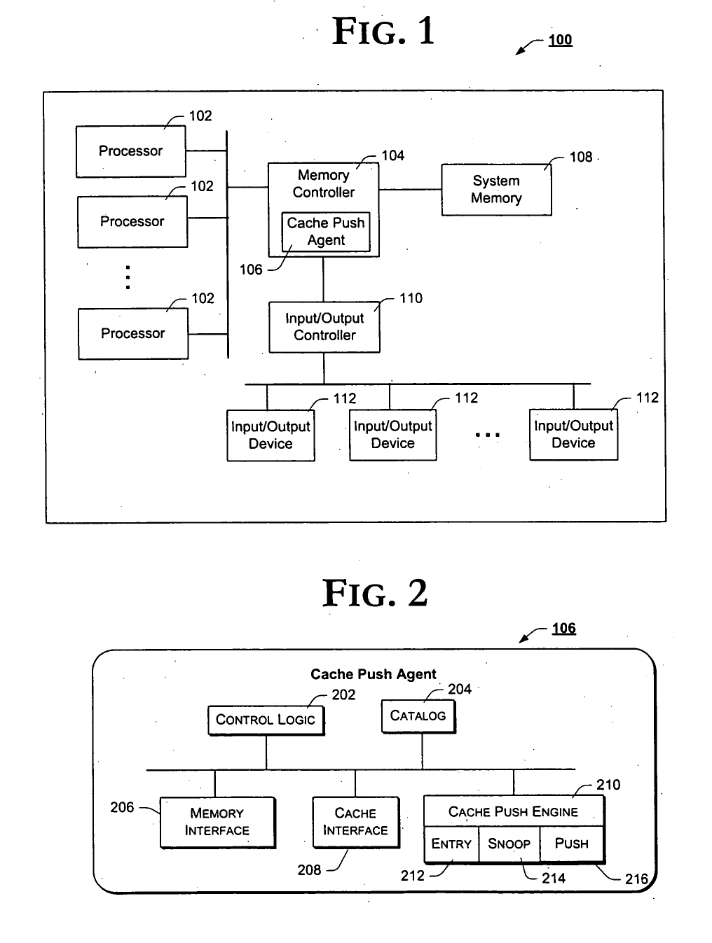

FIG. 1 is a block diagram of an example computing system suitable for implementing the cache push agent, in accordance with one example embodiment of the invention. Computing system 100 is intended to represent any of a wide variety of traditional and non-traditional computing systems, servers, network switches, network routers, wireless communication subscriber units, wireless communication telephony infrastructure elements, personal digital assistants, set-top boxes, or any electric appliance that would benefit from the teachings of the present invention. In accordance with the illustrated example embodiment, computing system 100 may include one or more of processor(s) 102, memory controller 104, cache push agent 106, system memory 108, input/output controller 110, and input/output device(s) 112 coupled as shown in FIG. 1. Cache push agent 106, as described more fully hereinafter, may well be used in computing systems of greater or lesser complexity than that depicted in FIG. 1. Also, the innovative attributes of cache push agent 106 as described more fully hereinafter may well be embodied in any combination of hardware and software.

Processor(s) 102 may represent any of a wide variety of control logic including, but not limited to one or more of a microprocessor, a programmable logic device (PLD), programmable logic array (PLA), application specific integrated circuit (ASIC), a microcontroller, and the like, although the present invention is not limited in this respect. In one embodiment, computing system 100 may be a web server, and processor(s) 102 may be one or more Intel® Itanium® 2 processor(s). Processor(s) 102 may have internal cache memory for low latency access to data and instructions. When data or instructions that are needed for execution by a processor 102 are not resident in internal cache memory, processor 102 may attempt to read the data or instructions from system memory 108.

Memory controller 104 may represent any type of chipset or control logic that interfaces system memory 108 with the other components of computing system 100. In one embodiment, the connection between processor(s) 102 and memory controller 104 may be referred to as a front-side bus. In another embodiment, memory controller 104 may be referred to as a north bridge.

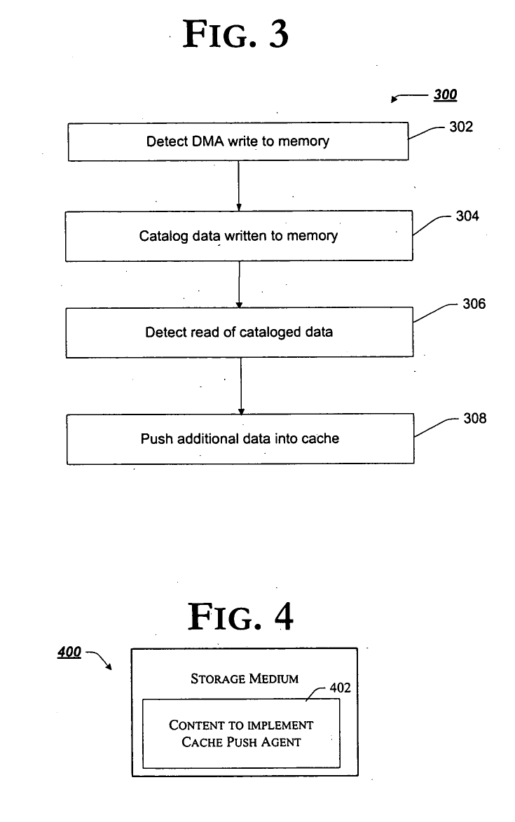

Cache push agent 106 may have an architecture as described in greater detail with reference to FIG. 2. Cache push agent 106 may also perform one or more methods for managing wireless network channel width capabilities, such as the method described in greater detail with reference to FIG. 3. While shown as being part of memory controller 104, cache push agent 106 may well be part of another component or may be implemented in software or a combination of hardware and software.

System memory 108 may represent any type of memory device(s) used to store data and instructions that may have been or will be used by processor(s) 102. Typically, though the invention is not limited in this respect, system memory 108 will consist of dynamic random access memory (DRAM). In one embodiment, system memory 108 may consist of Rambus DRAM (RDRAM). In another embodiment, system memory 108 may consist of double data rate synchronous DRAM (DDRSDRAM). The present invention, however, is not limited to the examples of memory mentioned here.

Input/output (I/O) controller 110 may represent any type of chipset or control logic that interfaces I/O device(s) 112 with the other components of computing system 100. In one embodiment, though the present invention is not so limited, I/O controller 110 may comply with the Peripheral Component Interconnect (PCI) ExpressTm Base Specification, Revision 1.0a, PCI Special Interest Group, released Apr. 15, 2003. In another embodiment, I/O controller 110 may be referred to as a south bridge.

Input/output (I/O) device(s) 112 may represent any type of device, peripheral or component that provides input to or processes output from computing system 100. In one embodiment, though the present invention is not so limited, at least one I/O device 112 may be a network interface controller with the capability to perform Direct Memory Access (DMA) operations to copy data into system memory 108. In this respect, there may be a software Transmission Control Protocol with Internet Protocol (TCP/IP) stack being executed by processor(s) 102 that will process the contents in system memory 108 as a result of a DMA by I/O device 112 as TCP/IP packets are received. I/O device(s) 112 may further be capable of informing cache push agent 106 of the contents of a DMA, for example, the memory locations of the descriptor, header, and payload of a TCP/IP packet received. I/O device(s) 112 in particular, and the present invention in general, are not limited, however, to network interface controllers. In other embodiments, at least one I/O device 112 may be a graphics controller or disk controller, or another controller that may benefit from the teachings of the present invention.

FIG. 2 is a block diagram of an example cache push agent architecture, in accordance with one example embodiment of the invention. As shown, cache push agent 106 may include one or more of control logic 202, catalog 204, memory interface 206, cache interface 208, and cache push engine 210 coupled as shown in FIG. 2. In accordance with one aspect of the present invention, to be developed more fully below, cache push agent 106 may include a cache push engine 210 comprising one or more of entry services 212, snoop services 214, and/or push services 216. It is to be appreciated that, although depicted as a number of disparate functional blocks, one or more of elements 202-216 may well be combined into one or more multi-functional blocks. Similarly, cache push engine 210 may well be practiced with fewer functional blocks, i.e., with only push services 216, without deviating from the spirit and scope of the present invention, and may well be implemented in hardware, software, firmware, or any combination thereof. In this regard, cache push agent 106 in general, and cache push engine 210 in particular, are merely illustrative of one example implementation of one aspect of the present invention. As used herein, cache push agent 106 may well be embodied in hardware, software, firmware and/or any combination thereof.

As introduced above, cache push agent 106 may have the ability to push contents of memory into a cache of a processor in response to a memory read by the processor of associated contents. In one embodiment, cache push agent 106 may maintain a table, possibly containing address ranges or data, of memory writes by an I/O device(s) 112. In another embodiment, cache push agent 106 may snoop for system memory 108 reads by processor(s) 102 and determine what, if any, data to push into the cache of processor(s) 102. One skilled in the art would appreciate that cache push agent 106 may improve the performance of computing system 100 by placing contents of system memory 108 that may soon be needed by processor(s) 102 into internal cache memory.

As used herein control logic 202 provides the logical interface between cache push agent 106 and its host computing system 100. In this regard, control logic 202 may manage one or more aspects of cache push agent 106 to provide a communication interface to other components of computing system 100, e.g., through memory interface 206 and cache interface 208.

According to one aspect of the present invention, though the claims are not so limited, control logic 202 may receive event indications such as, e.g., a DMA by I/O device(s) 112 or memory read by processor(s) 102. Upon receiving such an indication, control logic 202 may selectively invoke the resource(s) of cache push engine 210. As part of an example method for managing wireless network channel width capabilities, as explained in greater detail with reference to FIG. 3, control logic 202 may selectively invoke entry services 212 that may establish or modify one or more entries in a table of memory contents written by I/O device(s) 112. Control logic 202 also may selectively invoke snoop services 214 or push services 216, as explained in greater detail with reference to FIG. 3, to detect memory reads by processor(s) 102 of cataloged memory contents or to selectively push contents of memory into internal cache of processor(s) 102, respectively. As used herein, control logic 202 is intended to represent any of a wide variety of control logic known in the art and, as such, may well be implemented as a microprocessor, a micro-controller, a field-programmable gate array (FPGA), application specific integrated circuit (ASIC), programmable logic device (PLD) and the like. In some implementations, control logic 202 is intended to represent content (e.g., software instructions, etc.), which when executed implements the features of control logic 202 described herein.

Catalog 204 is intended to represent the storage of tables that may be created or used by cache push agent 106. According to one example implementation, though the claims are not so limited, catalog 204 may well include volatile and non-volatile memory elements, possibly random access memory (RAM) and/or read only memory (ROM). Catalog 204 may store a separate table for each I/O device 112. In one embodiment, catalog 204 may store a network packet information table that corresponds to a network interface controller I/O device 112. In another embodiment, catalog 204 may also store a data configuration table that is used by push services 216, as described hereinafter, to determine the number of cache lines to push based on the type of data being pushed. In one embodiment, settings and parameters of tables stored in catalog 204 may be loaded by device drivers corresponding to I/O devices 112. In another embodiment, configuration registers may be used that allow for dynamic control of table settings and parameters.

Memory interface 206 represents a path through which cache push agent 106 can access system memory 108. In one embodiment, memory interface 206 may be used to retrieve contents of system memory 108 to push contents into processor(s) 102. In another embodiment, memory interface 206 may provide a notification of a DMA write by I/O device(s) 112 or a memory read by processor(s) 102.

Cache interface 208 represents a path through which cache push agent 106 can access the internal cache of processor(s) 102. In one embodiment, cache interface 208 may be used to push contents into the internal cache of processor(s) 102. In another embodiment, cache interface 208 may provide a notification of change of status to the internal cache of processor(s) 102.

As introduced above, cache push engine 210 may be selectively invoked by control logic 202 to store table entries of memory writes by I/O device(s) 112, to detect memory reads by processor(s) 102, or to selectively push contents of system memory 108 into the internal cache of processor(s) 102. In accordance with the illustrated example implementation of FIG. 2, cache push engine 210 is depicted comprising one or more of entry services 212, snoop services 214 and push services 216. Although depicted as a number of disparate elements, those skilled in the art will appreciate that one or more elements 210-214 of cache push engine 210 may well be combined without deviating from the scope and spirit of the present invention.

Entry services 212, as introduced above, may provide cache push agent 106 with the ability to establish or modify entries in a table of memory contents written by I/O device(s) 112. In one example embodiment, entry services 212 may receive a special communication regarding a DMA write, perhaps a PCI Express™ communication, from I/O device(s) 112 generally contemporaneous to the DMA write into system memory 108. In another example embodiment, entry services 212 may be able to acquire needed information or data, for example data type, starting address and length, as a result of the DMA write. The contents included by entry services 212 into a table of memory writes by I/O device(s) 112 may include the type, starting address in system memory 108, length, and status (or state) of data written, and possibly even a portion or all of the data itself. In one embodiment, where I/O Device 112 is a network interface controller, the types of data can include descriptors, headers, and payloads of TCP/IP packets received. In another embodiment, the types of data can include even more data types, including perhaps some for different protocol specific portions of headers.

The status field that may be maintained by entry services 212 may include values for not ready (when the DMA operation has not started yet), in progress (when the DMA transfer for that entry is in progress), ready (when the DMA transfer for that entry is complete), prefetched (when there is a processor request for data within the address range of the entry), and invalid (when the table entry is either empty or invalid).

As introduced above, snoop services 214 may provide cache push agent 106 with the ability to detect memory reads by processor(s) 102 of cataloged memory contents. In one example embodiment, snoop services 214 may look for reads of system memory 108 by processor(s) 102 within the address ranges stored in catalog 204 by entry services 212. In another example embodiment, snoop services 214 may have the ability to detect changes in status of the lines of internal cache of processor(s) 102. In this way, snoop services 214 may be able to alert entry services 214 to change the status of an entry or to alert push services 216 to push contents of system memory 108 into the internal cache of one of processor(s) 102.

Push services 216, as introduced above, may provide cache push agent 106 with the ability to selectively push contents of memory into internal cache of processor(s) 102. In one embodiment, push services 216 may determine the number of cache lines of data to push based upon a data configuration table stored in catalog 204. This data configuration table may contain the number of cache lines of data to push based on the type of data requested. In another example embodiment, push services 216 may automatically push one cache line of data into each of processor(s) 102 when an entry status becomes ready. In one example embodiment, push services 216 may only push contents into the internal cache of a processor 102 that had previously requested system memory 108 contents with an address range of a table entry stored in catalog 204.

FIG. 3 is a flow chart of an example method performed by a cache push agent 106, in accordance with one example embodiment of the invention. It will be readily apparent to those of ordinary skill in the art that although the following operations may be described as a sequential process, many of the operations may in fact be performed in parallel or concurrently. In addition, the order of the operations may be re-arranged without departing from the spirit of embodiments of the invention.

According to but one example implementation, the method of FIG. 3 begins with cache push agent 106 detecting (302) a DMA write to system memory 108 by one of I/O device(s) 112. In one example embodiment, an I/O device 112 sends a communication to cache push agent 106 indicating the details of the DMA operation. In another example embodiment, cache push agent 106 may detect the DMA operation through monitoring of inbound writes to memory.

Next, control logic 202 may selectively invoke entry services 212 to catalog (304) information about the DMA write into a table. In one example embodiment, entry services 212 may create an entry in a table stored in catalog 204 including fields for data type, starting memory address, length, and state. In another example embodiment, entry services 212 may change or update the status of an entry in a table stored in catalog 204.

Control logic 202 may then selectively invoke snoop services 214 to detect (306) a request by a processor 102 for contents of system memory 108 within a cataloged address range. In one example embodiment, snoop services 214 may detect the change of status of a line of internal cache in processor(s) 102 that is cataloged in catalog 204. In another example embodiment, snoop services 214 may determine, based on a memory read transaction, that an entry in a table stored in catalog 204 has been requested by a processor 102.

Next, push services 216 may be selectively invoked by control logic 202 to push (308) additional data into the internal cache of the processor 102 that had requested the cataloged contents. In one embodiment, push services 216 may push the remaining contents within the address range of the entry from which the processor 102 had requested contents. In another embodiment, push services 216 may refer to a table stored in catalog 204 to determine the number of cache lines to push based on the type of data involved.

FIG. 4 illustrates a block diagram of an example storage medium comprising content which, when accessed, causes an electronic appliance to implement one or more aspects of the cache push agent 106 and/or associated method 300. In this regard, storage medium 400 includes content 402 (e.g., instructions, data, or any combination thereof) which, when executed, causes the machine to implement one or more aspects of cache push agent 106, described above.

The machine-readable (storage) medium 400 may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem, radio or network connection).

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Embodiments of the present invention may also be included in integrated circuit blocks referred to as core memory, cache memory, or other types of memory that store electronic instructions to be executed by the microprocessor or store data that may be used in arithmetic operations. In general, an embodiment using multistage domino logic in accordance with the claimed subject matter may provide a benefit to microprocessors, and in particular, may be incorporated into an address decoder for a memory device. Note that the embodiments may be integrated into radio systems or hand-held portable devices, especially when devices depend on reduced power consumption. Thus, laptop computers, cellular radiotelephone communication systems, two-way radio communication systems, one-way pagers, two-way pagers, personal communication systems (PCS), personal digital assistants (PDA's), cameras and other products are intended to be included within the scope of the present invention.

The present invention includes various operations. The operations of the present invention may be performed by hardware components, or may be embodied in machine-executable content (e.g., instructions), which may be used to cause a general-purpose or special-purpose processor or logic circuits programmed with the instructions to perform the operations. Alternatively, the operations may be performed by a combination of hardware and software. Moreover, although the invention has been described in the context of a computing system, those skilled in the art will appreciate that such functionality may well be embodied in any of number of alternate embodiments such as, for example, integrated within a communication appliance (e.g., a cellular telephone).

Many of the methods are described in their most basic form but operations can be added to or deleted from any of the methods and information can be added or subtracted from any of the described messages without departing from the basic scope of the present invention. Any number of variations of the inventive concept is anticipated within the scope and spirit of the present invention. In this regard, the particular illustrated example embodiments are not provided to limit the invention but merely to illustrate it. Thus, the scope of the present invention is not to be determined by the specific examples provided above but only by the plain language of the following claims.

1 A method comprising:
pushing contents of memory into a cache of a processor in response to a memory read by the processor of contents associated with the contents to be pushed.

2. The method of claim 1, further comprising:
cataloging memory writes by one or more input/output (I/O) device.

3. The method of claim 2, further comprising:
snooping memory reads by the processor to determine if any contents of a cataloged memory write are requested.

4. The method of claim 2, wherein the contents to be pushed are selected from the non-requested contents of a cataloged memory write.

5. The method of claim 2, wherein the cataloged memory writes are Direct Memory Access (DMA) writes.

6. The method of claim 2, wherein cataloging memory writes by one or more input/output (I/O) device comprises:
maintaining a table containing one or more fields selected from the group consisting of data type, starting address, length, state and data.

7. A system, comprising:
an input/output (I/O) device;
a processor, coupled with the I/O device, to execute instructions;
memory devices, coupled with the I/O device and the processor, to store contents; and
a cache push agent coupled with the processor and the memory devices, the cache push agent to selectively catalog memory writes by the I/O device and to selectively push memory contents into a cache of the processor in response to a memory read by the processor of cataloged memory contents.

8. The system of claim 7, wherein the I/O device comprises:
a network controller.

9. The system of claim 7, further comprising:
the cache push agent to maintain a table containing one or more fields selected from the group consisting of data type, starting address, length, state and data.

10. The system of claim 7, further comprising:
the cache push agent to determine the number of cache lines to push based at least in part on the data type being read by the processor.

11. A storage medium comprising content which, when executed by an accessing machine, causes the accessing machine to selectively push contents of memory into a cache of a processor in response to a memory read by the processor of a cataloged memory address.

12. The storage medium of claim 11, further comprising content which, when executed by the accessing machine, causes the accessing machine to maintain a table of memory writes by one or more input/output devices, the table containing one or more fields selected from the group consisting of data type, starting address, length, state and data.

13. The storage medium of claim 11, further comprising content which, when executed by the accessing machine, causes the accessing machine to maintain a table of data types, the table containing one or more fields selected from the group consisting of data type and number of cache lines to be pushed.

14. The storage medium of claim 11, further comprising content which, when executed by the accessing machine, causes the accessing machine to catalog Direct Memory Access (DMA) writes by a network controller.

15. The storage medium of claim 11, further comprising content which, when executed by the accessing machine, causes the accessing machine to catalog a memory address for one or more portions of a Transmission Control Protocol with Internet Protocol (TCP/IP) packet selected from the group consisting of descriptor, header, and payload.

16. An apparatus, comprising:
a memory interface to couple with memory devices;
a processor interface to couple with a processor; and
control logic coupled with the memory and processor interfaces, the control logic to selectively push contents of memory into a cache of the processor in response to a memory read by the processor of a cataloged memory address.

17. The apparatus of claim 16, further comprising an input/output (I/O) interface to couple with an I/O device.

18. The apparatus of claim 17, further comprising control logic to selectively catalog memory writes by the input/output (I/O) device.

19. The apparatus of claim 17, further comprising control logic to maintain a table containing one or more fields selected from the group consisting of data type, starting address, length, state and data.

20. The apparatus of claim 17, further comprising control logic to determine the number of cache lines to selectively push based at least in part on the data type being read by the processor.
